(19) United States
(12) Patent Application Publication
(10) Pub. No.: US 2018/0349896 A1
(43) Pub. Date: Dec. 6, 2018

(54) METHOD AND SYSTEM FOR ANONYMIZATION OF ELECTRONIC TRANSACTIONS VIA BLOCKCHAIN

(71) Applicant: Mastercard International Incorporated, Purchase, NY (US)

(72) Inventors: Ankur ARORA, Jasola (IN); Shashank Kumar TRIVEDI, New Delhi (IN); Ajay NEHRA, Gurgaon (IN)

(73) Assignee: Mastercard International Incorporated, Purchase, NY (US)

(21) Appl. No.: 15/613,724

(22) Filed: Jun. 5, 2017

(51) Int. Cl. G06Q 20/38; H04L 9/06; H04L 9/14; H04L 9/30; H04L 9/32

(52) U.S. Cl. CPC G06Q 20/3829; H04L 9/0637; H04L 9/14; G06Q 20/383; H04L 9/3247; G06Q 2220/00; H04L 9/30

(57) ABSTRACT

A method for anonymization of a blockchain transaction includes: storing a key pair comprising a private key and public key; receive an anonymization request from a computing device, the request including a destination address and transaction amount; transmitting an intermediate address based on the public key to the computing device; receiving one block in a blockchain, the one block being comprised of a block header and one or more transaction data values including a specific transaction data value comprised of the intermediate address and a transfer amount based on the transaction amount; generating a digital signature using the private key; and transmitting a new transaction data value and the digital signature to a node associated with the blockchain, the new transaction data value being comprised of the destination address and a payment amount related to the transaction amount.

### FIELD

The present disclosure relates to the anonymization of an electronic transaction conducted via a blockchain, specifically the use of one or more intermediary addresses to obscure the source and destination of funds in a blockchain transaction to increase anonymity of entities associated with blockchain addresses.

### BACKGROUND

In recent years, blockchain technology has seen increased usage when it comes to conducting electronic transactions via the Internet. In particular, many users are flocking to various digital currencies that utilize blockchains, such as Bitcoin, for the anonymity that blockchain transactions can provide. Specifically, it is often extremely difficult to identify the user behind a blockchain address, meaning that an individual can transfer or receive funds utilizing a blockchain while keeping a high level of anonymity.

However, the nature of the blockchain as an immutable ledger is such that every transaction can be traced and followed back to the genesis block of the blockchain. In other words, by analyzing the movement of digital currency in a blockchain through its transactions, and because all blockchain addresses associated with a particular blockchain wallet (e.g., a specific private key) and generated using the corresponding public key, it can be possible to identify and view all of the transactions associated with a specific blockchain wallet. Some users may be uncomfortable with having so much data attributed to their wallet, which can run counter to the primary aim of many users in using a blockchain: anonymity. For instance, such data may, as it is accumulated and analyzed, eventually reveal the user behind a wallet or at least provide information about them, such as geographic location, interests, spending habits, etc. However, the existing communications and attribution structure of blockchain technology such as Bitcoin require identification of where the transactions are emanating and terminating, in order to maintain the ledger. This creates a technical problem of competing interests within the technology.

Thus, there is a need for a technical solution to increase the anonymization of a wallet and the user associated therewith in a blockchain.

### SUMMARY

The present disclosure provides a description of systems and methods for the anonymization of a blockchain transaction. Anonymization of the transactions themselves, rather than just the users behind any individual wallet, can obscure all actions that are being performed with a particular wallet, which may result in analysis of the wallet yielding little to no information about the user behind the wallet. The methods and systems discussed herein use intermediary addresses to obfuscate the source and destination of funds for transactions conducted via the blockchain, which would result in showing the user only transferring funds to and receiving funds from a small number of addresses that are also involved in a significantly large volume of transactions with various other users, thereby rendering the data innocuous. In some cases, the amounts themselves may also be obscured through the use of multiple transfers involving multiple addresses, which may further increase the anonymity provided by the systems and methods discussed herein.

A method for anonymization of a blockchain transaction includes: storing, in a memory of a processing server, a first key pair comprising a first private key and a corresponding first public key; receiving, by a receiving device of the processing server, an anonymization request from a computing device, wherein the anonymization request includes at least a destination address and a transaction amount; electronically transmitting, by a transmitting device of the processing server, an intermediate address based on the first public key to the computing device; receiving, by the receiving device of the processing server, at least one block in a blockchain, wherein the at least one block is comprised of at least a block header and one or more transaction data values including a specific transaction data value comprised of at least the intermediate address and a transfer amount based on the transaction amount; generating, by a generation module of the processing server, a first digital signature using at least the first private key stored in the memory; and electronically transmitting, by the transmitting device of the processing server, at least a new transaction data value and the first digital signature to a node associated with the blockchain, wherein the new transaction data value is comprised of at least the destination address and a payment amount related to the transaction amount.

A system for anonymization of a blockchain transaction includes: a generation module of a processing server; a memory of the processing server configured to store a first key pair comprising a first private key and a corresponding first public key; a receiving device of the processing server configured to receive an anonymization request from a computing device, wherein the anonymization request includes at least a destination address and a transaction amount; and a transmitting device of the processing server configured to electronically transmit an intermediate address based on the first public key to the computing device, wherein the receiving device of the processing server is further configured to receive at least one block in a blockchain, wherein the at least one block is comprised of at least a block header and one or more transaction data values including a specific transaction data value comprised of at least the intermediate address and a transfer amount based on the transaction amount, the generation module of the processing server is configured to generate a first digital signature using at least the first private key stored in the memory, and the transmitting device of the processing server is further configured to electronically transmit at least a new transaction data value and the first digital signature to a node associated with the blockchain, wherein the new transaction data value is comprised of at least the destination address and a payment amount related to the transaction amount.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the anonymization of blockchain transactions in accordance with exemplary embodiments.

FIG. 2 is a block diagram illustrating the processing server of the system of FIG. 1 for the anonymization of electronic transactions conducted via blockchain in accordance with exemplary embodiments.

FIGS. 3A and 3B are a flow diagram illustrating a process for the anonymization of an electronic transaction conducted via blockchain in the system of FIG. 1 in accordance with exemplary embodiments.

FIG. 4 is a flow chart illustrating an exemplary method for anonymization of a blockchain transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Anonymization of Blockchain Transactions

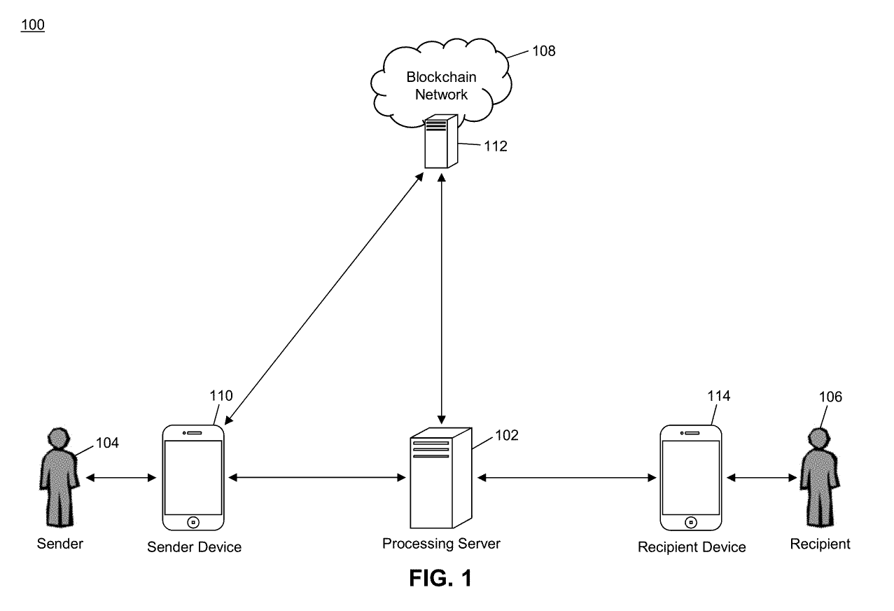

FIG. 1 illustrates a system 100 for the anonymization of electronic transactions conducted via a blockchain via the obfuscation of the source and destination of funds, as well as potential obfuscation of the amount of funds being transferred in any given blockchain transaction.

The system 100 may include a processing server 102. The processing server 102, discussed in more detail below, may be configured to anonymize electronic transactions that are conducted via a blockchain. As discussed herein, transactions conducted via a blockchain may comprise any type of electronic transaction, including the transfer of digital currency (e.g., Bitcoin, virtual amounts of fiat currencies, etc.), as well as any other electronic transaction for which there is a source address and destination address, such as the transfer of data. In other words, the methods and systems discussed herein may be applicable to any type of electronic transaction that utilizes a blockchain. While the system 100 may be described with respect to a transfer of digital currency, the techniques discussed herein are thus applicable to any type of electronic transaction.

In the system 100, a sender 104 may wish to send an amount of digital currency (e.g., or other digitally transferrable data or asset) to a recipient 106 via a blockchain. The blockchain may be associated with a blockchain network 108, which may be comprised of a plurality of different blockchain nodes 112, each configured to receive new transaction requests, generate blocks, validate blocks, and store the complete blockchain to comprise a decentralized system. Traditionally, to conduct an electronic transaction via the blockchain associated with the blockchain network 108, the sender 104 may use a computing device associated therewith, referred to herein as the sender device 110, to electronically transmit a transaction request to a blockchain node 112. The sender device 110 may be any type of computing device suitable for performing the functions discussed herein, such as a desktop computer, laptop computer, notebook computer, tablet computer, cellular phone, smart phone, smart watch, smart television, implantable computing device, wearable computing device, etc., that is configured to operate as a blockchain wallet.

A blockchain wallet may comprise a private key of a cryptographic key pair. The cryptographic key pair may be comprised of a private key and a corresponding public key, which may be generated by the sender device 110 or other device and provisioned thereto using standard key generation techniques. The private key may be stored in the sender device 110, with the corresponding public key being provided to the blockchain nodes 112 comprising the blockchain network 108.

In a traditional blockchain transaction, the sender device 110 may electronically transmit the transaction request to a blockchain node 112, where the transaction request may include at least a destination address, a transfer amount, and a digital signature. The destination address may be a blockchain address generated by a public key of a blockchain wallet associated with the recipient 106, such as may be stored in the recipient's own computing device, referred to herein as a recipient device 114. The recipient device 114 may use the public key corresponding to its own private key to generate an address using a suitable algorithm associated with the blockchain network 108, which may be provided to the sender device 110 using any suitable communication mechanism, such as electronic transmission via near field communication, the display of a machine-readable code read by an optical imager of the sender device 110, etc. The transfer amount may be an amount of digital currency or other data that is to be transferred from the sender's blockchain wallet to the recipient's blockchain wallet.

The digital signature may be a data value generated via the private key comprising the sender's blockchain wallet. The digital signature may serve as proof of the sender's ownership of the blockchain wallet, which may thus prove the sender's ownership of all currency transferred to that blockchain wallet (e.g., destination addresses for earlier transactions generated via the wallet's corresponding public key). The blockchain node 112 receiving the transaction request may be configured to validate the digital signature, such as using the corresponding public key, which may serve as proof of access by the sender 104 to the currency transferred to the blockchain wallet. Once the ownership is validated, the blockchain node 112 will generate a new transaction that will be added into a new block that is validated and added to the blockchain, resulting in the transfer amount being transferred to the recipient's blockchain wallet, which may then be usable in a later transaction where the recipient device 114 may generate a digital signature to prove ownership of the transfer amount. It will be apparent to persons having skill in the relevant art that, in some instances, additional data may be included in the transaction request and used by the blockchain node 112 in effecting transactions, such as the inclusion of transaction identifiers that identify prior transfers to the sender's blockchain wallet for use by the blockchain node 112 in validating the digital signature and proving ownership of a sufficient amount (e.g., at least equal to the transfer amount) of digital currency.

In such traditional transactions, an entity reviewing the data included in the blocks comprising the blockchain may be able to identify all transfers associated with the sender's and receiver's blockchain wallets, thus compromising the anonymity of the sender 104 and recipient 106. In the system 100, the processing server 102 may serve as an intermediary that may result in increasing the anonymity of the sender 104, the recipient 106, and even the transactions themselves. To make a transfer of a specific amount of digital currency, the sender 104 may electronically transmit a transfer request, also referred to herein as an anonymization request, to the processing server 102 via the sender device 110. The transfer request may be submitted to the processing server 102 using any suitable communication method, such as via a web page, an application program associated with the processing server 102, a short messaging service message, etc.

The transfer request may include at least the sender's digital signature, the destination address of the recipient 106, and the specific amount being transferred. In some embodiments, the transfer request may include information identifying the recipient device 114 in place of the destination address, where such identifying information may include a device identifier associated with the recipient device 114 used for communication therewith, such as a telephone number, e-mail address, media access control address, internet protocol address, etc. In such embodiments, the processing server 102 may be configured to communicate with the recipient device 114 to obtain a destination address therefrom.

The processing server 102 may have at least one blockchain wallet of its own. Upon receipt of the transfer request, the processing server 102 may generate (e.g., using the public key of its blockchain wallet) a destination address, referred to herein as an intermediary address. The processing server 102 may electronically transmit the intermediary address to the sender device 110. The sender 104 may then, using the sender device 110, initiate a blockchain transaction with the blockchain network 108 (e.g., via a blockchain node 112 thereof) for the transfer of the specific amount of digital currency from their blockchain wallet (e.g., validated via its digital signature) to the intermediary address. The blockchain network 108 may process the transaction, which may include the inclusion of a transaction record in a new block that is generated and added to the blockchain associated with the blockchain network 108.

The blockchain may be comprised of a plurality of blocks. Each block may be comprised of at least a block header and one or more transaction records. Each transaction record may be associated with a blockchain transaction and may include an amount being transferred and an address to which the amount was transferred, and may, in some cases, also include a source, which may be a blockchain address, a digital signature, and/or one or more identifiers identifying prior transaction records that serve as a source of the transferred amount. It will be apparent to persons having skill in the relevant art that additional data may be included in some transaction records, such as multiple destination addresses and transfer amounts, such as to account for change returning to the sender's blockchain wallet.

Each block header in a block may be comprised of at least a timestamp, a block reference value, and a transaction reference value. The timestamp may be a time at which the respective block was generated for addition to the blockchain, or other similar time. The block reference value may be a reference to the block most recently added to the blockchain (e.g., identifiable via the timestamp included therein) prior to the respective block. In some cases, the block reference value may be a hash value generated from hashing the block header of the prior block. The transaction reference value may be a reference to the one or more transaction records included in the respective block. In some cases, the transaction reference value may be a hash value generated from hashing the transaction record(s) in the respective block. The use of the reference values may ensure immutability of the blockchain, as no transaction record could be modified without necessitating a change in the block header's transaction reference value, where such a change would also necessitate a change in the subsequent block's block reference value, itself necessitating a change to the next block and so on through every remaining block in the blockchain. Due to the frequency of blocks being added, and due to the blockchain data being stored at each of the blockchain nodes 112 comprising the blockchain network 108, such a modification to every block header in each copy of the blockchain may be mechanically impossible.

Once the transaction submitted by the sender 104 is added to the blockchain, the processing server 102 may verify that the transfer of the specific amount to the processing server's blockchain wallet occurred. Such verification may include review of the recently added blocks to identify a transaction record for transfer of the specific amount to the intermediary address provided to the sender device 110. In some cases, the sender device 110 may receive a transaction confirmation from the blockchain node 112, which may include a transaction record identifier, which may be a unique value associated with a transaction record, such as an identification number, which the sender device 110 may provide to the processing server 102, where the processing server 102 may use the identifier to quickly identify the transaction record in the blockchain corresponding to the transfer, for verification thereof.

Once the transfer has been verified, the processing server 102 may submit a transaction request to a blockchain node 112 for a second transaction, for the transfer of the specific amount from the processing server's blockchain wallet to that of the recipient 106. The transaction request may include at least the destination address associated with the recipient device 114, the transfer amount (e.g., less any fees), and a digital signature generated by the processing server 102 using the private key corresponding to the public key used to generate the intermediary address. The blockchain node 112 may receive the request and may process the transaction to transfer the specific amount from the processing server's blockchain wallet to that of the recipient device 114. In some embodiments, the processing server 102 may notify the sender device 110 and/or the recipient device 114 of the transfer, which may also include the providing of a transaction record identifier for the second transaction.

As a result, the sender 104 may transfer a specific amount of digital currency to the recipient 106 with increased anonymity, as the blockchain may reflect only that the sender 104 sent currency to the processing server 102 and that the recipient 106 received currency from the processing server 102. When using the processing server 102 across multiple transactions, and with multiple entities using the processing server 102, the true source or destination for any transaction is obscured to the point of being impossible to identify. If used for each transaction, a nefarious actor looking at the transactions for the sender 104 will only see transfers to and from the processing server 102, thus revealing no information about the sender's spending habits, thus protecting the sender's anonymity.

In some embodiments, the processing server 102 may utilize multiple blockchain wallets to further increase anonymity. In such embodiments, the processing server 102 may possess a plurality of different cryptographic key pairs. The processing server 102 may utilize a first key pair in generating the intermediary address, but may utilize a second key pair in performing the second transaction. As a result, even in cases of a low volume of transactions, a transfer from the sender 104 to the recipient 106 may be obscured as the blockchain will reflect to independent transactions: a transfer from the sender 105 to a first wallet, and a receipt by the recipient 106 from a second wallet. In such embodiments, the blockchain wallets utilized by the processing server 102 may each maintain a suitable level of digital currency, which may be maintained via blockchain transactions to effect transfers between its blockchain wallets.

In some embodiments, the processing server 102 may also anonymize transactions via the obscuring of transfer amounts. In such embodiments, the processing server 102 may break up the second transaction (e.g., the transfer to the recipient's blockchain wallet) into multiple transactions, where the total amounts from each of the transactions equals the specific amount being transferred to the recipient 106 by the sender 104. In some cases, each of the transactions may transfer an equal amount of currency (e.g., a total transfer of 36 units of currency may be accomplished in three transactions of 12 units of currency). In other cases, the transactions may be limited to a predetermined amount and performed accordingly (e.g., the transfer of 36 units may be accomplished in three transactions of 10 units of currency and a fourth transaction of 6 units of currency, where the processing server 102 may limit transfers to 10 units of currency). In yet other cases, the transactions may be required to exceed a predetermined amount (e.g., the transfer of 36 minutes may be accomplished by two transactions of 10 units and a third transaction of 16 unit to ensure a minimum of 10 units per transaction). In such embodiments, amounts being transferred into and out of the blockchain wallet of the processing server 102 may be different, which may make further increase the difficulty to match a sender 104 to a recipient 106 for any transaction, let alone across multiple transactions.

In some instances, the processing server 102 may utilize both multiple blockchain wallets and multiple transactions to further increase anonymity of senders, recipients, and individual transactions. For instance, the sender 104 may transfer a specific amount to a first blockchain wallet of the processing server 102, such as 36 units of currency. The processing server 102 may then utilize three other blockchain wallets to perform three other transactions: a second wallet to transfer 10 units of currency to the recipient 106, a third wallet to transfer 10 units of currency to the recipient 106, and a fourth wallet to transfer 6 units of currency to the recipient 106. This may further increase the anonymity provided by the processing server 102 to senders 104 and recipients 106, making it close to impossible, if not entirely impossible, to match any sender 104 or recipient 106 to one another for even a single transaction, let alone across multiple transactions, thus ensuring complete anonymity for a sender's or recipient's behavior using the blockchain.

### Processing Server

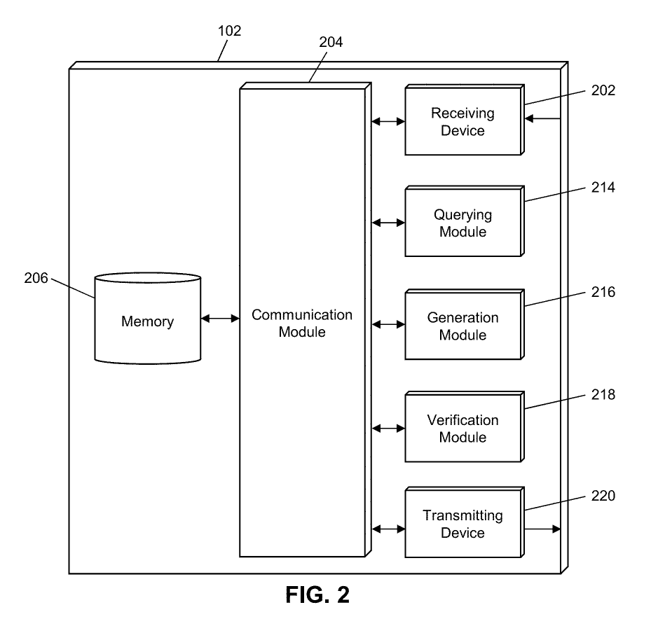

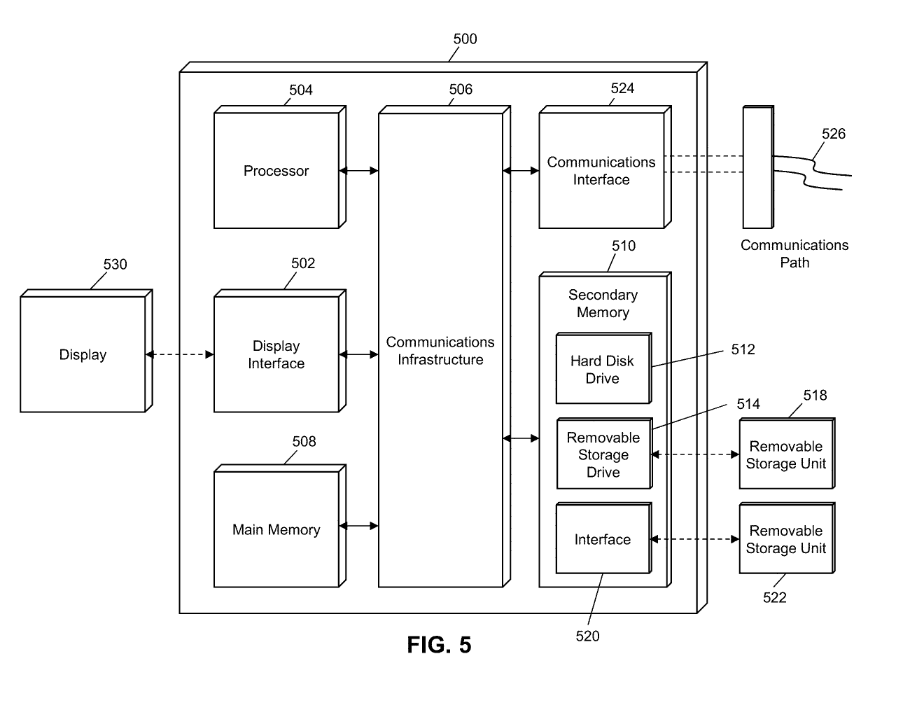

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from sender devices 110, blockchain nodes 112, recipient devices 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by sender devices 110 that may be superimposed or otherwise encoded with transaction requests. Transaction requests may include at least a transfer amount and one of: a destination address or data associated with a recipient device 114. In some cases, a transaction request may also include a digital signature. In some embodiments, the receiving device 202 may also receive data signals electronically transmitted by sender devices 110 that are superimposed or otherwise encoded with transaction records for use in verifying blockchain transactions. The receiving device 202 may be configured to receive data signals electronically transmitted by blockchain nodes 112 that are superimposed or otherwise encoded with blockchain data, including newly added blocks and/or transaction record identifiers associated with transfers requested by the processing server 102. In some cases, the receiving device 202 may be configured to receive data signals electronically transmitted by recipient devices 114, such as may be superimposed or otherwise encoded with a destination address.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, verification module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a memory 206. The memory 206 may be configured to store data for use by the processing server 102 in performing the functions discussed herein, such as public and private keys, symmetric keys, etc. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein.

The memory 206 may be configured to store one or more cryptographic key pairs, each key pair comprising at least a private key and a corresponding public key. In some cases, the memory 206 may be configured to store a blockchain. As discussed above, the blockchain may be comprised of a plurality of blocks, where each block may be comprised of at least a block header and one or more transaction records. Each block header may include a timestamp, a block reference value referring to the preceding block in the blockchain, and a transaction reference value referring to the one or more transaction records included in the respective block. The memory 206 may also be configured to store any additional data that may be used by the processing server 102 in performing the functions discussed herein, communication data for communicating with blockchain nodes 112 and other computing devices, key generation algorithms, digital signature generation algorithms, etc.

The processing server 102 may include a querying module 214. The querying module 214 may be configured to execute queries on databases to identify information. The querying module 214 may receive one or more data values or query strings, and may execute a query string based thereon on an indicated database, such as the memory 206, to identify information stored therein. The querying module 214 may then output the identified information to an appropriate engine or module of the processing server 102 as necessary. The querying module 214 may, for example, execute a query on the memory 206 to identify a public key for use in generating an intermediary address or a private key for use in generating a digital signature for use in performing the functions of the processing server 102 as discussed herein.

The processing server 102 may also include a generation module 216. The generation module 216 may be configured to generate data for the processing server 102 for use in performing the functions discussed herein. The generation module 216 may receive instructions as input, may generate data based on the instructions, and may output the generated data to one or more modules or engines of the processing server 102. For example, the generation module 216 may be configured to generate digital signatures from private keys using suitable signature generation algorithms. The generation module 216 may also be configured to generate blockchain addresses via public keys using suitable generation algorithms, such as may be specified by the corresponding blockchain network 108.

The processing server 102 may also include a verification module 218. The verification module 218 may be configured to verify data for the processing server 102 for use in performing the functions discussed herein. The verification module 218 may receive instructions as input, may verify data as instructed, and may output a result of the verification to another module or engine of the processing server 102. For example, the verification module 218 may be configured to verify that blockchain transactions have been successfully completed, such as by comparing data in a transaction record stored in the blockchain to previously received data, such as verifying that the sender 104 sent the specific currency amount to the intermediary address provided by the processing server 102 to the sender device 110 or to verify that the recipient 106 received the amount transferred by the processing server 102.

The processing server 102 may also include a transmitting device 220. The transmitting device 220 may be configured to transmit data over one or more networks via one or more network protocols. In some instances, the transmitting device 220 may be configured to transmit data to sender devices 110, blockchain nodes 112, recipient devices 114, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to sender devices 110, which may be superimposed or otherwise encoded with an intermediary address for use in transferring digital currency to the processing server 102 via blockchain. The transmitting device 220 may also be configured to electronically transmit data signals to sender devices 110 that are superimposed or otherwise encoded with notifications regarding successful completion of a transfer to the recipient 106. The transmitting device 220 may be configured to electronically transmit data signals to blockchain nodes 112, which may be superimposed or otherwise encoded with transfer requests, which may request a blockchain transaction be performed, and include at least a digital signature, destination address, and an amount being transferred. In some embodiments, the transmitting device 220 may be further configured to electronically transmit data signals to recipient devices 114, which may be superimposed or otherwise encoded with notifications regarding successful transfers or requests for a destination address.

### Process for Anonymization of a Blockchain Transaction

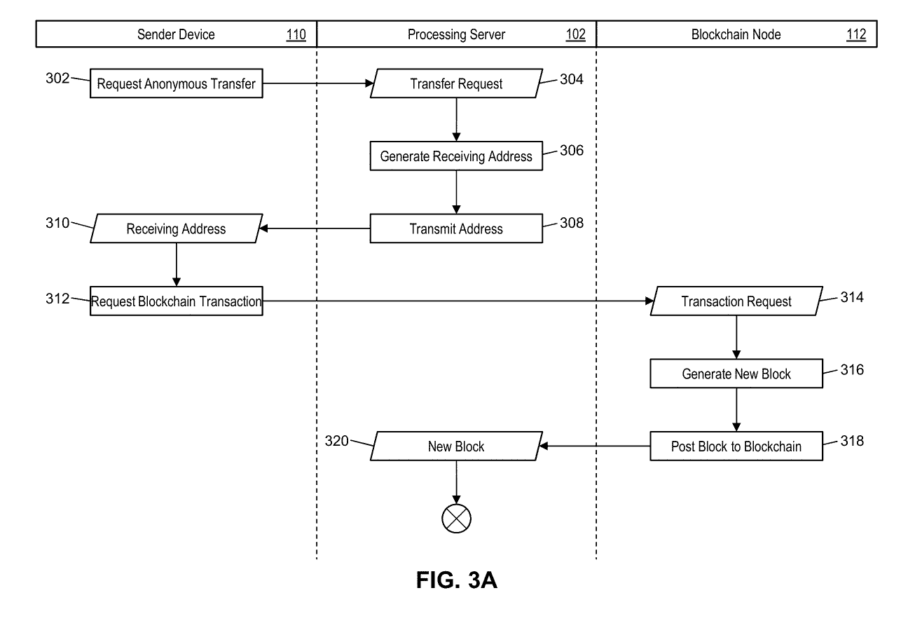

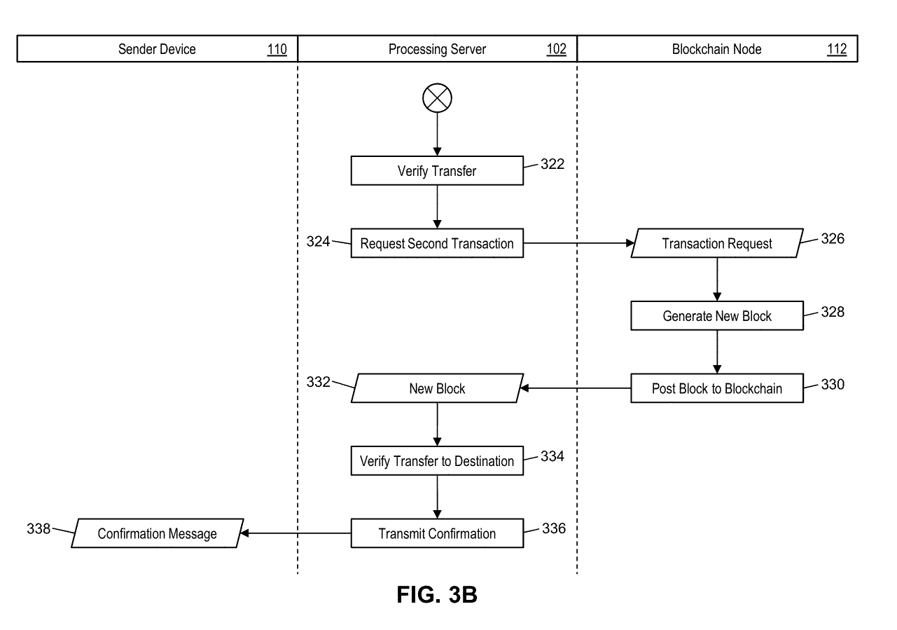

FIGS. 3A and 3B illustrate a process for the anonymization of an electronic transaction conducted via blockchain in the system 100 of FIG. 1.

In step 302, the sender device 110 may electronically transmit a request for an anonymous transfer of digital currency via blockchain to the processing server 102 using a suitable communication method. In step 304, the receiving device 202 of the processing server 102 may receive the request. The request may include at least a destination address (e.g., generated using the public key associated with the recipient device 114) and a transfer amount. In step 306, the generation module 216 of the processing server 102 may generate an intermediary address using a private key stored in the memory 206 of the processing server 102. In step 308, the transmitting device 220 of the processing server 102 may electronically transmit the intermediary address to the sender device 110. In some cases, the transfer amount may include fees. In other cases, step 308 may include the transmission of an amount of fees to be added to the transfer amount, or an increased transfer amount.

In step 310, the sender device 110 may receive the intermediary address from the processing server 102. In step 312, the sender 104 may use the sending device 110 to initiate a blockchain transaction by submitting a transaction request to a blockchain node 112 associated with the blockchain network 108, which may also include the generation of a digital signature for inclusion therein. In step 314, the blockchain node 114 may receive the transaction request, which may include at least the intermediary address, the transfer amount (e.g., increased, as applicable), and a digital signature generated via the private key associated with the sender device 110. In step 316, the blockchain node 112 may generate a new block for addition to the blockchain that includes a transaction record for transfer of the transfer amount from the sender's blockchain wallet to the intermediary address provided by the processing server 102. In step 318, the new block may be verified and posted to the blockchain, by being transmitted to all of the blockchain nodes 112 and made publicly accessible.

In step 320, the receiving device 202 of the processing server 102 may receive the newly added block, which includes the new transaction record corresponding to the transfer from the sender 104 to the processing server 102. In step 322, the verification module 218 of the processing server 102 may verify that the transfer took place and was for the correct amount, such as by identifying a transaction record that includes the intermediary address as the destination address and by verifying that the amount transferred in the transaction is correct (e.g., equal to the increased transfer amount). Following the verification, in step 324 the transmitting device 220 of the processing server 102 may electronically transmit a transaction request for a second transaction to the blockchain node 112 using a suitable communication network. As part of the submission of the transaction request, the generation module 216 of the processing server 102 may generate a digital signature using a private key stored in the memory 206 of the processing server 102, which may correspond to the public key used to generate the intermediary address, or may be part of a different key pair in cases where multiple blockchain wallets are being utilized by the processing server 102.

In step 326, the blockchain node 112 may receive the transaction request, which may include at least the destination address, the transfer amount, and the digital signature generated by the processing server 102. In step 328, the blockchain node 112 may validate the digital signature and the processing server's access to the associated funds, and may generate a new block for addition to the blockchain that includes a transaction record for second transaction. In step 330, the new block may be verified and posted to the blockchain, by being transmitted to all of the blockchain nodes 112 and made publicly accessible.

In step 332, the receiving device 202 of the processing server 102 may receive the newly added block, which may include a transaction record corresponding to the second transaction. In step 334, the verification module 218 of the processing server 102 may verify that the second transaction was successfully processed and was correct, such as by verifying the transfer of the transfer amount to the destination address specified in the initial request for an anonymous transaction. Once the verification is completed, then, in step 336, the transmitting device 220 of the processing server 102 may electronically transmit a confirmation message to the sender device 110. In step 338, the sender device 110 may receive the confirmation message. The confirmation message may indicate that the recipient 106 receive the transfer amount successfully. In some cases, the confirmation message may include a transaction record identifier associated with the transaction record corresponding to the second transaction.

### Exemplary Method for Anonymization of a Blockchain Transaction

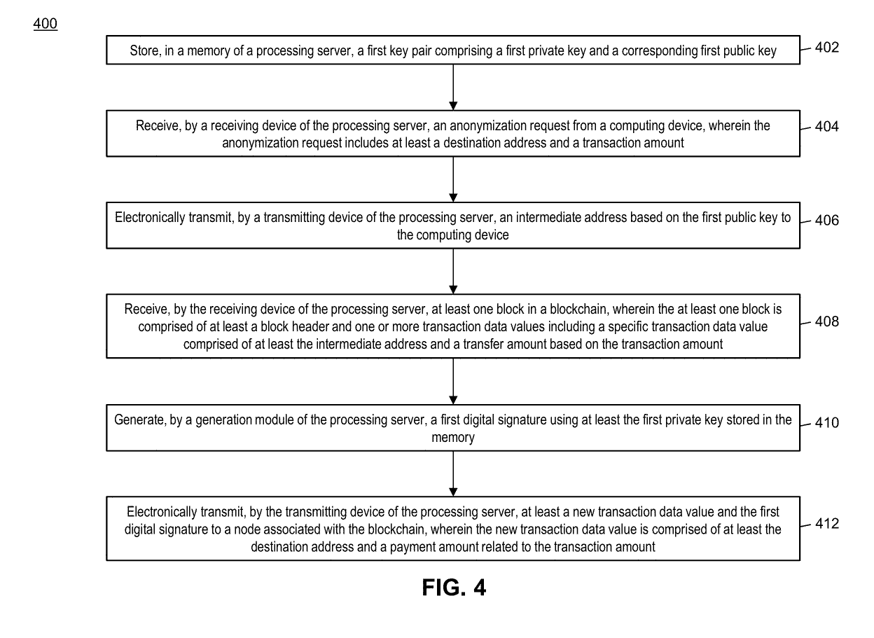

FIG. 4 illustrates a method 400 for the anonymization of an electronic transaction conducted via blockchain through the use of an intermediary.

In step 402, a first key pair may be stored in a memory (e.g., the memory 206) of a processing server (e.g., the processing server 106), wherein the first key pair is comprised of a first private key and a corresponding public key. In step 404, an anonymization request may be received by a receiving device (e.g., the receiving device 202) of the processing server from a computing device (e.g., the sender device 110), wherein the anonymization request includes at least a destination address and a transaction amount.

In step 406, an intermediate address may be electronically transmitted by a transmitting device (e.g., the transmitting device 220) of the processing server to the computing device, where the intermediate address is based on the first public key. In step 408, at least one block in a blockchain may be received by the receiving device of the processing server, wherein the at least one block is comprised of at least a block header and one or more transaction data values including a specific transaction data value comprised of at least the intermediate address and a transfer amount based on the transaction amount.

In step 410, a first digital signature may be generated by a generation module (e.g., the generation module 216) of the processing server using at least the first private key stored in the memory. In step 412, at least a new transaction data value and the first digital signature may be electronically transmitted by the transmitting device of the processing server to a node (e.g., a blockchain node 112) associated with the blockchain, wherein the new transaction data value is comprised of at least the destination address and a payment amount related to the transaction amount.

In one embodiment, the method 400 may further include: receiving, by the receiving device of the processing server, a new block in the blockchain, wherein the new block is comprised of at least a block header and one or more transaction data values including an additional transaction data value; and verifying, by a verification module (e.g., the verification module 218) of the processing server, that the additional transaction value includes the destination address and the payment amount. In some embodiments, the method 400 may also include storing, in the memory of the processing server, a second key pair comprising a second private key and a corresponding second public key, wherein the first digital signature is generated using the second private key in place of the first private key. In one embodiment, the payment amount may be equal to the transaction amount. In some embodiments, the transfer amount may be greater than the transaction amount.

In one embodiment, the method 400 may further include: generating, by the generation module of the processing server, a second digital signature using at least the first private key stored in the memory; and electronically transmitting, by the transmitting device of the processing server, at least an additional transaction data value and the second digital signature to a node associated with the blockchain, wherein the additional transaction data value is comprised of at least the destination address and a second payment amount, wherein a combination of the payment amount and the second payment amount are equal to the transaction amount. In a further embodiment, the payment amount and the second payment amount may be equal. In another further embodiment, the payment amount and the second payment amount may be greater than a predetermined value.

### Computer System Architecture

FIG. 5 illustrates a computer system 500 in which embodiments of the present disclosure, or portions thereof, may be implemented as computer-readable code. For example, the computing device 102 of FIG. 1 may be implemented in the computer system 500 using hardware, as well as software, firmware, non-transitory computer readable media having instructions stored thereon, or a combination thereof and may be implemented in one or more computer systems or other processing systems that are specifically configured to perform the functions discussed herein. Hardware may embody modules and components used to implement the methods of FIGS. 3A, 3B, and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device, that are specifically configured to perform the functions discussed herein. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3A, 3B, and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods anonymization of a blockchain transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for anonymization of a blockchain transaction, comprising:
storing, in a memory of a processing server, a first key pair comprising a first private key and a corresponding first public key;
receiving, by a receiving device of the processing server, an anonymization request from a computing device, wherein the anonymization request includes at least a destination address and a transaction amount;
electronically transmitting, by a transmitting device of the processing server, an intermediate address based on the first public key to the computing device;
receiving, by the receiving device of the processing server, at least one block in a blockchain, wherein the at least one block is comprised of at least a block header and one or more transaction data values including a specific transaction data value comprised of at least the intermediate address and a transfer amount based on the transaction amount;
generating, by a generation module of the processing server, a first digital signature using at least the first private key stored in the memory; and
electronically transmitting, by the transmitting device of the processing server, at least a new transaction data value and the first digital signature to a node associated with the blockchain, wherein the new transaction data value is comprised of at least the destination address and a payment amount related to the transaction amount.

2. The method of claim 1, further comprising:
receiving, by the receiving device of the processing server, a new block in the blockchain, wherein the new block is comprised of at least a block header and one or more transaction data values including an additional transaction data value; and
verifying, by a verification module of the processing server, that the additional transaction value includes the destination address and the payment amount.

3. The method of claim 1, further comprising:
storing, in the memory of the processing server, a second key pair comprising a second private key and a corresponding second public key, wherein
the first digital signature is generated using the second private key in place of the first private key.

4. The method of claim 1, further comprising:
generating, by the generation module of the processing server, a second digital signature using at least the first private key stored in the memory; and
electronically transmitting, by the transmitting device of the processing server, at least an additional transaction data value and the second digital signature to a node associated with the blockchain, wherein the additional transaction data value is comprised of at least the destination address and a second payment amount, wherein
a combination of the payment amount and the second payment amount are equal to the transaction amount.

5. The method of claim 4, wherein the payment amount and the second payment amount are equal.

6. The method of claim 4, wherein the payment amount and the second payment amount are greater than a predetermined value.

7. The method of claim 1, wherein the payment amount is equal to the transaction amount.

8. The method of claim 1, wherein the transfer amount is greater than the transaction amount.

9. A system for anonymization of a blockchain transaction, comprising:
a generation module of a processing server;
a memory of the processing server configured to store a first key pair comprising a first private key and a corresponding first public key;
a receiving device of the processing server configured to receive an anonymization request from a computing device, wherein the anonymization request includes at least a destination address and a transaction amount; and
a transmitting device of the processing server configured to electronically transmit an intermediate address based on the first public key to the computing device, wherein
the receiving device of the processing server is further configured to receive at least one block in a blockchain, wherein the at least one block is comprised of at least a block header and one or more transaction data values including a specific transaction data value comprised of at least the intermediate address and a transfer amount based on the transaction amount,
the generation module of the processing server is configured to generate a first digital signature using at least the first private key stored in the memory, and the transmitting device of the processing server is further configured to electronically transmit at least a new transaction data value and the first digital signature to a node associated with the blockchain, wherein the new transaction data value is comprised of at least the destination address and a payment amount related to the transaction amount.

10. The system of claim 9, further comprising:
a verification module of the processing server, wherein
the receiving device of the processing server is further configured to receive a new block in the blockchain, wherein the new block is comprised of at least a block header and one or more transaction data values including an additional transaction data value, and
the verification module of the processing server is configured to verify that the additional transaction value includes the destination address and the payment amount.

11. The system of claim 9, wherein,
the memory of the processing server, a second key pair comprising a second private key and a corresponding second public key, and
the first digital signature is generated using the second private key in place of the first private key.

12. The system of claim 9, wherein
the generation module of the processing server is further configured to generate a second digital signature using at least the first private key stored in the memory,
the transmitting device of the processing server is further configured to electronically transmit at least an additional transaction data value and the second digital signature to a node associated with the blockchain, wherein the additional transaction data value is comprised of at least the destination address and a second payment amount, and
a combination of the payment amount and the second payment amount are equal to the transaction amount.

13. The system of claim 12, wherein the payment amount and the second payment amount are equal.

14. The system of claim 12, wherein the payment amount and the second payment amount are greater than a predetermined value.

15. The system of claim 9, wherein the payment amount is equal to the transaction amount.

16. The system of claim 9, wherein the transfer amount is greater than the transaction amount.
